(19) United States
(12) Patent Application Publication
(10) Pub. No.: US 2014/0025528 A1
(43) Pub. Date: Jan. 23, 2014

(54) COMPUTER PROGRAM, METHOD, AND SYSTEM FOR IN-HOME SERVICE VISITS

(71) Applicant: Russell William Duker, Columbia, MO (US)

(72) Inventor: Russell William Duker, Columbia, MO (US)

(21) Appl. No.: 13/832,889

(22) Filed: Mar. 15, 2013

Related U.S. Application Data
(60) Provisional application No. 61/673,333, filed on Jul. 19, 2012.

(51) Int. Cl. G06Q 30/06

(52) U.S. Cl. CPC G06Q 30/0621
USPC 705/26.5

(57) ABSTRACT

A computer program, method, and system for facilitating and conducting in-home service visits. In more detail, the computer program, method, and system provide for an interactive user interface for guiding a service technician through a customizable process for completing in-home service visits. The customizable process may include receiving a customer request for the service technician to conduct the in-home service. During the in-home service visit, the customer may be presented with primary package proposals corresponding to a primary service of the in-home service visit. In addition, the customer may be presented with one or more consumer questions requesting information regarding one or more secondary services that may be performed. Thereafter, the answers to the one or more consumer questions may be analyzed to determine secondary package proposals corresponding to the one or more secondary services.

### RELATED APPLICATIONS

This non-provisional patent application claims priority benefit, with regard to all common subject matter, of earlier-filed U.S. Provisional Patent Application No. 61/673,333, filed Jul. 19, 2012, and entitled “METHOD, COMPUTER PROGRAM, AND SYSTEM FOR IN-HOME SERVICE VISITS.” The identified earlier-filed provisional patent application is hereby incorporated by reference in its entirety into the present application.

### FIELD

Embodiments of the present invention provide a computer program, a method, and a system for facilitating and conducting in-home service visits. More particularly, embodiments of the present invention provide an interactive user interface for guiding a service technician through a customizable process for completing in-home service visits.

### BACKGROUND

A significant number of companies and service providers operate under a business model whereby the companies send out technically trained persons (hereinafter “service technicians”) into the field to perform in-home service visits at personal or commercial residences. It is difficult to control the service technician's productivity and performance levels because the companies cannot maintain appropriate oversight over the service technicians while they are in the field. As a result, the quality of the service technician's work, the satisfaction of the customer, and the performance of the company may all significantly suffer or otherwise may not be optimized.

### SUMMARY

Embodiments of the present invention provide for a computer program, method, and system directed to facilitating in-home service visits. Embodiments of the present invention perform the initial step of receiving an indication of a customer request for the in-home service visit to be performed by a service technician, with a purpose of the in-home service visit being for the service technician to perform a primary service at a residence of the customer. In the next step, the customer is presented with primary package proposals corresponding to the primary service. The customer is additionally presented with one or more consumer questions requesting information regarding one or more secondary services that may be performed at the customer's residence. In the next step, information indicative of answers to the one or more consumer questions is received. Thereafter, embodiments of the present invention analyze the answers to the one or more consumer questions to determine secondary package proposals corresponding to the one or more secondary services. In the final step, the customer is presented with the secondary package proposals.

Embodiments of the present invention provide for an additional computer program, method, and system directed to facilitating in-home service visits. Embodiments of the present invention perform the initial step of receiving an indication of a customer request for the in-home service visit to be performed by a service technician, with a purpose of the in-home service visit being for the service technician to perform a primary service at a residence of the customer. In the next step, the customer is presented with primary package proposals corresponding to the primary service. In the next step, the service technician is presented with one or more technician questions requesting information regarding one or more secondary services that may be performed at the customer's residence. In the next step, information indicative of answers to the one or more technician questions is received. Thereafter, embodiments of the present invention analyze the answers to the one or more technician questions to determine secondary package proposals corresponding to the one or more secondary services. In the final step, the customer is presented with the secondary package proposals.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a flow chart of a method of facilitating an in-home service visit according to embodiments of the present invention;

FIG. 2 is a schematic depiction of a system for facilitating in-home service visits in accordance with embodiments of the present invention;

FIG. 3 is a depiction of a log-in screen, including input panes, according to embodiments of the present invention;

FIG. 4 is a depiction of a welcome screen, including a welcome message, according to embodiments of the present invention;

FIG. 5 is a depiction of a consumer question screen, including consumer questions, according to embodiments of the present invention;

FIG. 6 is a depiction of a technician question screen, including technician questions, according to embodiments of the present invention;

FIG. 7 is a depiction of a repair topics screen, including recommended repair topics, according to embodiments of the present invention;

FIG. 8 is a depiction of a package proposal screen, including package proposals, according to embodiments of the present invention;

FIG. 9 is a depiction of a summary screen according to embodiments of the present invention;

FIG. 10 is a flow chart of an additional method of facilitating an in-home service visit according to embodiments of the present invention;

FIG. 11 is a depiction of a work order screen according to embodiments of the present invention; and

FIG. 12 is a depiction of a signature screen according to embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for facilitating in-home service visits by service technicians. As used herein, a service technician is referred to as an employee or an independent contractor that is employed by or contracted by, respectively, a service company to perform services on items within the home or business of a customer. Such services may include repairs, maintenances, updates or the like. In addition, such services may include various types of work, including electrical, plumbing, heating ventilation and air-conditioning (HVAC), appliance repair, etc. However, such descriptions of services are provided for exemplary purposes and are not intended to be limiting. Additionally, the terms “in-home” and “home” may broadly include personal residences or commercial residences. Thus, although certain descriptions may be provided herein with respect to personal residences (e.g., homes, apartments, etc.) of individual customers, it is understood that embodiments of the present invention may equally be applied to commercial residences of commercial customers.

The computer program, method, and system of embodiments of the present invention facilitate in-home service visits by guiding service technicians through each stage of an in-home service visit. In particular, embodiments of the present invention may be implemented to guide service technicians through a pre-service visit stage, an in-home service visit stage, and a post-service visit stage. The pre-service visit stage may include, for example: accepting an in-home service visit, ensuring that the service technician is physically prepared to conduct the in-home service visit, ensuring that the service technician has appropriate tools, equipment, and/or supplies necessary to complete the in-home service visit, or the like. The in-home service visit stage may include, for instance: interacting with customers, providing descriptions of services, materials, and costs, conducting the services, accepting payments, or the like. The post-service visit stage may include, for instance: obtaining service satisfaction information from the customer, re-ordering materials and equipment, accepting a new in-home service visit, or the like. Thus, embodiments of the present invention are directed to facilitating and guiding a service technician through all stages of an in-home service visit.

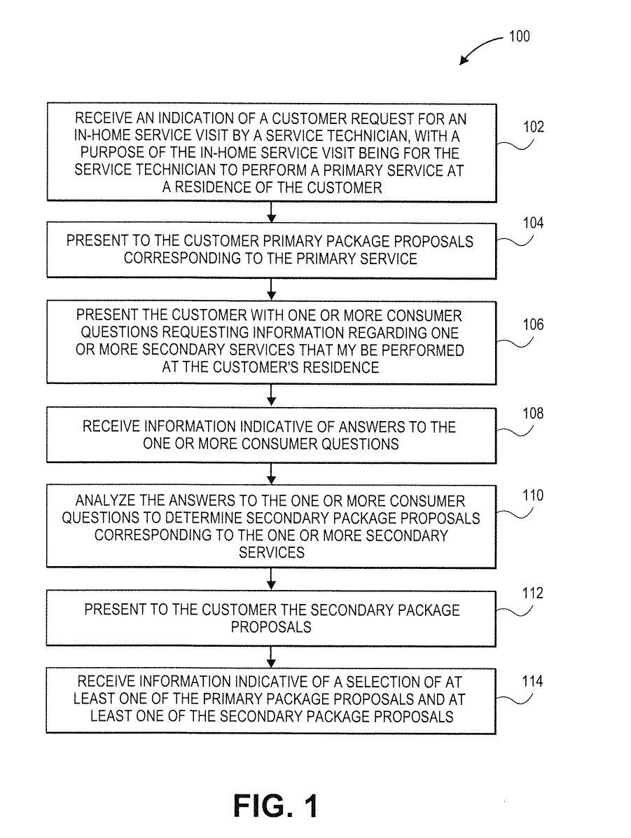

As illustrated in FIG. 1, embodiments of the present invention may include a method 100 with an initial Step 102 of receiving an indication of a customer request for the in-home service visit by a service technician, with a purpose of the in-home service visit being for the service technician to perform a primary service at a residence of the customer. For example, the primary service may be to perform maintenance on the customer's bathroom sink, which has a leaking faucet. In the next Step 104, the customer is presented with primary package proposals corresponding to the primary service. For instance, the primary package proposals may include various choices of tools, equipment, or supplies that can be used by the service technician to perform the primary service. In Step 106, the customer is additionally presented with one or more consumer questions requesting information regarding one or more secondary services that may be performed at the customer's residence. As an example, the customer may be asked whether the customer is aware of any toilets that run excessively. In the next Step 108, information indicative of answers to the one or more consumer questions is received. Thereafter, in Step 110, embodiments of the present invention analyze the answers to the one or more consumer questions to determine secondary package proposals corresponding to the one or more secondary services. In the next Step 112, the customer is presented with the secondary package proposals. Remaining with the example above, if the customer indicates that one of customer's toilets does run excessively, then the presented secondary package proposals may include a package proposal directed at servicing the customer's faulty toilet. Finally, in Step 114, information indicative of a selection of at least one of the primary package proposals and at least one of the secondary package proposals is received. Thus, embodiments of the present invention are directed to facilitating in-home service visits, and particularly to facilitating a service technician's interaction with a customer during performance of an in-home service visit.

The computer program of embodiments of the present invention comprises a plurality of code segments executable by a computing device for performing the steps of the method of the present invention. The steps of the method may be performed in the order shown in FIG. 1, or they may be performed in a different order. Furthermore, some steps may be performed concurrently as opposed to sequentially. Also, some steps may be optional.

System Description

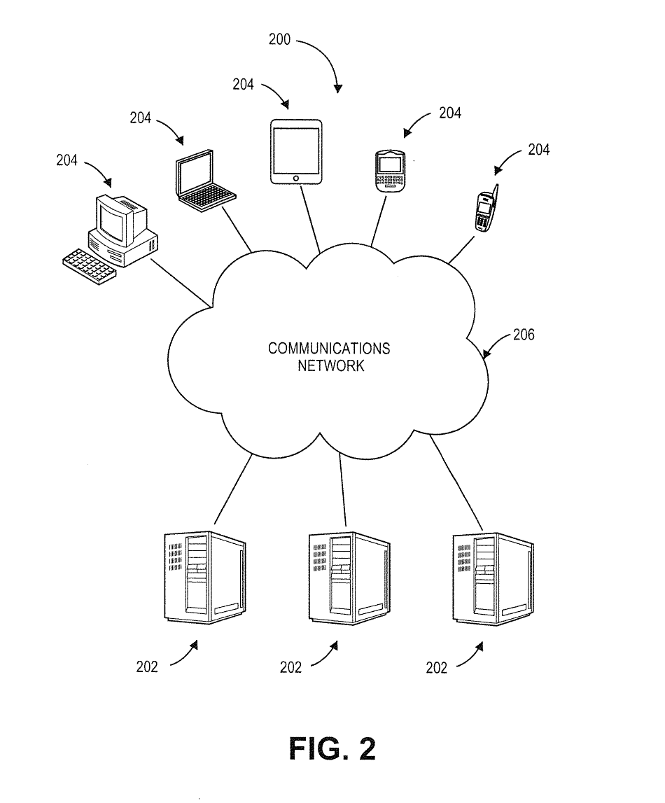

The computer program, system, and method of embodiments of the present invention may be implemented in hardware, software, firmware, or combinations thereof using the in-home service visit management system 200, shown in FIG. 2, which broadly comprises server devices 202, computing devices 204, and a communications network 206. The server devices 202 may include computing devices that provide access to one or more general computing resources, such as Internet services, electronic mail services, data transfer services, and the like. The server devices 202 may also provide access to a database that stores information and data necessary for the implementation of the computer program, method, and embodiments of the present invention.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores, such as may be included in the associated database, comprising a plurality of hard disk drives, network attached storage, or a separate storage network. The functionality of server devices 202 may also be distributed amongst many different computers in a cloud computing environment.

At least one of the server devices 202 may operate and/or host a website and/or a mobile application accessible by at least some of the external computing devices 204. The server device 202 may include conventional web hosting operating software, an Internet connection, such as a cable connection, satellite connection, DSL converter, or ISDN converter, and is assigned a URL and corresponding domain name so that the website hosted thereon can be accessed via the Internet in a conventional manner. In embodiments of the invention where the server device 202 implements a mobile application (i.e., an “app”), the server device may host and support software and services of proprietary mobile application providers, such as Google, Apple, and Blackberry. For example, some server devices 202 may support Google Android mobile applications, while other server devices may support Apple iPhone mobile applications.

The computing devices 204 may specifically include mobile communication devices (including wireless devices), work stations, desktop computers, laptop computers, palmtop computers, tablet computers, portable digital assistants, smart phones, and the like, or combinations thereof. Various embodiments of the computing device 204 may also include voice communication devices, such as cell phones or landline phones. In preferred embodiments, the computing device 204 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, discussed in more detail below. In additional preferred embodiments, the computing device 204 may include an optical device such as a digital camera, video camera, optical canner, or the like, such that the computing device can capture, store, and transmit digital images and/or videos.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing devices 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks, public switched telephone networks, fiber optic networks, or the like.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection.

The computer program of the present invention may run on computing devices 204 or, alternatively, may run on one or more server devices 202. Thus, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. For example, information may be stored on a memory element associated with the server device 202, with such information being remotely accessible to users of the computer program via one or more computing devices 204. Alternatively, information may be directly stored on the memory element associated with the one or more computing devices 204 of the user. In additional embodiments of the present invention, portions of information related may be stored on the server device 202, while other portions may be stored on the one or more computing devices 204. The various actions and calculations described herein as being performed by or using the computer program may actually be performed by one or more computers, processors, or other computational devices, such as the computing devices 204 and/or server devices 202, independently or cooperatively executing portions of the computer program.

In certain embodiments of the present invention, the computer program may be embodied as a stand-alone program downloaded on a user's computing device 204 or in a web-accessible program that is accessible by the user's computing device 204 via the network 206, each of which being functional to access an electronic resource. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via the electronic resource, such as a mobile “app” or website. For the web-accessible computer program, the user may simply access the computer program via the network 206 (e.g., the Internet) with the computing device 204.

Once the user has access to the electronic resource, via the computer program installed on a user's computing device 204 or the web, certain embodiments may provide for users to create accounts with which to access the electronic resource. The user accounts may be stored within the memory elements of the computing device 204, the server 206, or in the associated database. Certain embodiments of the present invention may provide for at least two types of user accounts, including a technician account and an admin account. Each user account may provide users with unique roles, capabilities, and permissions with respect to implementing embodiments of the present invention. However, such embodiments are provided for exemplary purposes only, and other embodiments of the present invention may include any number and/or any specific types of account as may be necessary to carry out the functions, features, and/or implementations of the present invention.

The technician account is an account created by or for a service technician. As was briefly described above and as will be discussed in more detail below, the service technician may make use of various embodiments of the present invention to facilitate in-home service visits. The service technician may logon to the technician account to access the electronic resource via a computing device 204. As previously noted, the computing device 204 may be selected from a plurality of computing devices. However, in certain embodiments, the computing device 204 will be a mobile device, such as a tablet, a laptop, a smart phone, or a personal digital assistant that is connected to a wireless network, such that the service technician can access the electronic resource during all stages of an in-home service visit, and specifically while the service technician is away from any available wired network connections.

The admin account is an account established by or for an administrative user of embodiments of the present invention. The administrative user may be an employee or independent contractor that is employed by or contracted by, respectively, a service company to manage and/or oversee one or more service technicians. For instance, the administrative user may use various embodiments of the present invention to track and manage one or more in-home service visits and to coordinate and dispatch service technicians to the one or more in-home service visits. In additional embodiments of the present invention, the administrative user may be responsible for establishing and managing the technician accounts, such that the administrative user can add, delete, modify, enable, or disable user accounts.

As will be discussed in more detail below, it may be necessary for customers to interact with certain functions and features of embodiments of the present invention. In such embodiments, the customer may create or be provided with a customer account. However, in other embodiments, the customer may not be required to have access to a customer account, and may simply interact with embodiments of the present invention from a service technician's computing device 204, via the service technician's technician account.

Although certain details and descriptions provided below discuss certain functions, features, and/or implementations of the present invention being carried out by a particular type of user or user account, it is hereby understood that such descriptions are simply provided for illustrative purposes. Thus, for example, certain functions described below as being performed by specific users and/or specific types of accounts may, in certain embodiments, be performed by other types of users and/or other types of accounts. Similarly, embodiments of the present invention may include other additional types of users and accounts, as may be necessary to implement embodiments of the present invention.

Regardless of the type of user account created, each user with an account may be required to enter, or have entered, various pieces of identification information, such as email address, name, home/work address, date of birth, or the like. In addition, the user may be required to enter or will otherwise be provided with a username and password, which may be required for the user to login to the user's account and access the electronic resource. All information entered by the user is received, via the network 206, and may be stored on the computing device 204, the server device 202, or associated inventory database.

Although certain embodiments of the present invention may require a user to establish an account, certain other embodiments may provide for certain features of the present invention to be utilized, without requiring the establishment of an account. For instance, a potential customer may browse in-home service visits options offered by a service company, order an in-home service visit from the service company, or the like, without needing to establish an account or log-in to access the electronic resource.

Operation

As described, embodiments of the present invention facilitate an in-home service visit by guiding a service technician through each stage of the in-home service visit. The following description details procedures by which embodiments of the present invention may be carried out and/or implemented. As a user progresses through the steps and/or actions of the procedures, the user may go back and review or re-perform certain steps and/or actions; however, in certain embodiments, the user may not progress forward or advance to a new step and/or action until all of the previous steps and/or actions have been completed. In still other embodiments, the user may perform any of the steps and/or actions in any order, as may be required. The computer program of embodiments of the present invention comprises a plurality of code segments executable by a computing device for performing certain steps and/or actions of the present invention. As noted then, the steps and/or actions of the computer program and method may be performed in the order provided below, or they may be performed in a different order. Furthermore, some steps and/or actions may be performed concurrently as opposed to sequentially. Also, some steps and or actions may be optional.

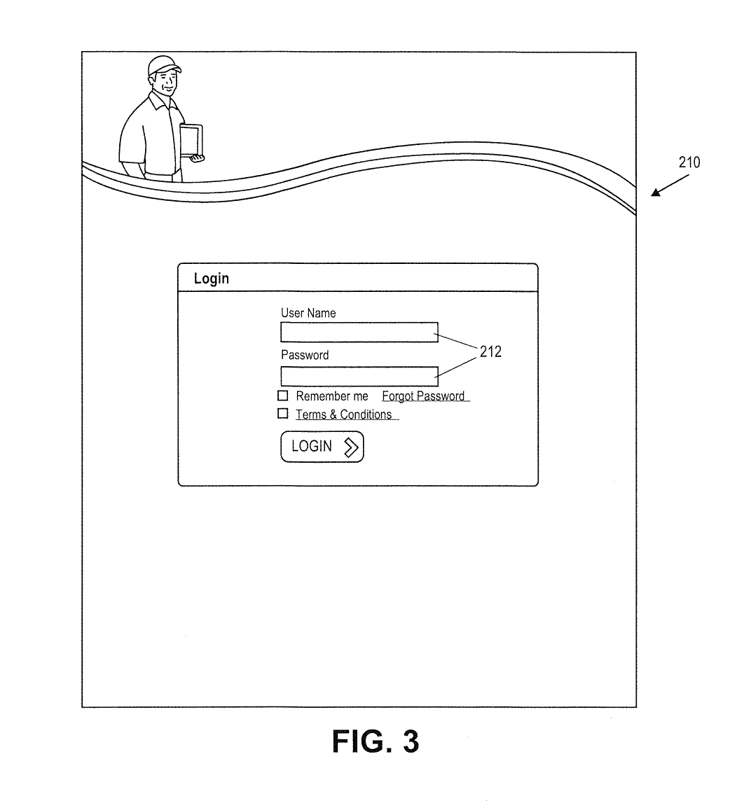

Beginning with the pre-service visit stage, embodiments of the present invention facilitate service technicians to prepare for an in-home service visit and to ensure that they have the tools, equipment, and supplies necessary to perform the in-home service visit. As previously noted, service technicians may generally implement embodiments of the present invention by accessing the electronic resource via a computing device 204. In certain embodiments, the service technician may interact with the electronic resource through the GUI of the computing device 204, as displayed on the electronic display of the computing device. Through the GUI, the electronic resource may initially provide for a log-in screen 210, such as illustrated in FIG. 3, to be presented. The log-in screen 210 may include one or more input panes 212 into which the service technician can enter the technician user's username and password to access the technician account. In certain embodiments, the log-in screen 210 may provide selectable icons from which may be displayed customizable terms and conditions. In such embodiments, the service technician may be required agree to such terms and conditions before the service technician's log-in can be verified and before the service technician can access additional embodiments of the present invention.

Upon logging-in through the log-in screen 210, the service technician may be presented, via the GUI, with initial instructions that must be viewed before the service technician may continue. The initial instructions may include a textual message, an audio message, a video message, or combinations thereof. The initial instructions are fully customizable, and may for instance, be related to training, education, regulations, or other requirements that the service company requires for the service technician to review. After viewing the initial instructions, embodiments of the present invention may provide for various questions relating to the initial instructions to be presented and displayed to the service technician. Such questions may be provided to insure that the service technician sufficiently understood and comprehended the initial instructions. Through the GUI, the technician must correctly select appropriate answers to the question before being permitted to move on to additional embodiments of the present invention.

Upon completing the questions corresponding to the initial instructions, the service technician may next be prompted to enter information regarding the service technician's service vehicle and to perform certain daily inventory of tools, equipment, supplies, or the like (hereinafter “supplies”). For instance, the service technician may be required to input a vehicle number of the service vehicle that the service technician will be operating during the in-home service visit. Additionally, if the service technician's service vehicle houses all of the service technician's supplies, the service technician may be prompted to inspect the service vehicle to ensure that the vehicle is holding all of supplies that the service technician is normally required to carry. Further, the service technician may be prompted to perform certain maintenance functions on the service vehicle, such as check the oil, fuel, or other fluid levels. In certain embodiments, before the service technician can continue with embodiments of the present invention, the service technician may be required to acknowledge, via the GUI, that such inventory and/or maintenance requirements were performed.

Once the service technician has acknowledged performing inventory and maintenance of the service vehicle, the service technician may be presented, via the GUI, with a service call screen that displays all requested in-home service visits that are available to be performed by the service technician. The available in-home service visits that are displayed to the service technician may be selected for display by an administrative user acting in a dispatcher capacity. For instance, a customer may request an in-home service visit via embodiments of the present invention. Such a request may be received via the electronic resource, a telephone call, an email, or the like. The customer may request the in-home service visit because the customer requires a service technician to repair or to perform maintenance on an item in the customer's residence as part of a primary service. Upon receiving the request, the administrative user registers the in-home service visit request and provides for the requested in-home service visit to be presented to the service technician. The service technician must select one or more of the displayed in-home service visits to perform. The selection may be made by selecting, clicking, or highlighting an appropriate icon, check-box, or the like, via the GUI. Once a requested in-home service visit has been selected, embodiments of the present information provide for a notification to be sent to the customer and/or the administrative user, informing them that the requested in-home service visit has been accepted and the service technician will soon be en route to a location of the customer's residence to perform the in-home service visit. If the customer had previously provided a telephone number, email address, or the like, then the customer's notification may be sent by phone call, email, text message, or the like. The administrative user's notification may similarly be sent by phone call, email, text message, or the like. Alternatively, the administrative user's notification may be provided via the electronic display of the administrative user's computing device 204.

After accepting a requested and displayed in-home service visit, embodiments of the present invention may provide for a plurality of pre-servicing questions to be displayed and presented to the service technician via the GUI. In certain embodiments, the service technician must correctly select answers to the pre-servicing questions before continuing with embodiments of the present invention and before performing the in-home service visit. The pre-servicing questions are fully customizable by the service technician's service company and/or the administrative user. In certain embodiments, the pre-servicing questions may be directed to 1) behavior modification and/or motivation, and 2) in-home service visit preparedness. The pre-servicing questions related to behavior modification and/or motivation may include questions directed to maintaining or improving the behavior of the service technician or the safety of the service technician's actions. For example, such pre-service questions may include: “IS YOUR WORK VEHICLE CLEAN,” “DID YOU SHAVE THIS MORNING,” or “WILL YOU WEAR YOUR SEATBELT WHILE DRIVING TODAY.” The pre-service questions related to in-home service visit preparedness may be directed to whether or not the service technician has the necessary supplies or is otherwise fully prepared to perform the in-home visit. For example, such questions may include “DO YOU HAVE ALL OF THE TOOLS YOU NEED TO PERFORM THE IN-HOME SERVICE VISIT” or “IS THERE ENOUGH TIME LEFT IN THE WORKDAY TO PERFORM THE IN-HOME SERVICE VISIT.” The service technician is required to correctly or sufficiently answer each of the pre-service questions before advancing through to additional embodiments of the present invention.

Embodiments of the present invention additionally provide for the service technician to be provided with a public pre-servicing message that summarizes the purpose of the selected in-home service visit. The public pre-servicing message may be presented to the service technician as a textual, audio, or video message via the computing device 204. The public pre-servicing message may also be sent to the customer via phone call, email, text message or the like. In addition to the public pre-servicing message, a private pre-servicing message may be presented to the service technician. The private pre-servicing message may not be sent to the customer and may include customer history information or other personal customer information that may be beneficial for the service technician to be aware of before performing the in-home service visit. For instance, the customer history information may include a listing of previous in-home service visits, previously repaired items or performed work, and previous payments or debts. As an additional example, personal customer information may include general customer information, such as whether the customer has a pet. Thus, the private pre-servicing message may be presented to the service technician to make the service technician aware that the service technician may encounter a pet during performance of the in-home service visit. However, such examples are purely exemplary, and it is understood that the private pre-service message may include any message that may be beneficial for the service technician to know before performing the in-home service visit. The service technician may be required to acknowledge, via the GUI, any public and/or private pre-servicing messages before continuing to additional embodiments of the present invention.

Before the service technician begins traveling to the location of the in-home repair visit, the service technician may be required to enter a starting mileage of the service technician's service vehicle, via the GUI. Embodiments of the present invention provide for integration and use of geo-location services such as Google™ Maps, Yahoo™ Maps, Bing™ Maps, or the like. Embodiments of the present invention may interact with such geo-location services, such as through an application programming interface (API), to determine a starting position for the service technician based on the global positioning system (GPS) included in the service technician's computing device 204 or service vehicle. After the service technician has entered the service vehicle's starting mileage and departs for the in-home service visit, a preferred route may be determined and an approximate distance and an approximate drive time to the in-home service visit location may be calculated. A notification may thereafter be sent to the customer via phone call, email, text message, or the like, which notifies the customer of the approximate time the service technician will be arriving for the in-home service visit. A similar notification may be sent to the administrative user. A graphical representation of the preferred route may also be displayed to the service technician via the GUI of the computing device 204. Once the service technician completes the route and arrives at the location of the in-home service visit, embodiments of the present invention send an additional notification to the customer and the administrative user notifying each that the service technician has arrived. The service technician may thereafter be required to enter the vehicle's final mileage. Embodiments of the present invention, through interaction with the geo-location services, may further determine an actual drive time, an actual mileage traveled, and an actual route, from which a comparison may be made with the approximate drive, the approximate distance, and the preferred route that were each previously determined. Said comparisons may be used to determine whether the service technician was following posted speed limits, made any unauthorized stops, traveled by the preferred route, or any other information that the service technician's service company considers pertinent. Such information may be stored in the server devices 202 or the associated database for recordkeeping and/or for further analysis.

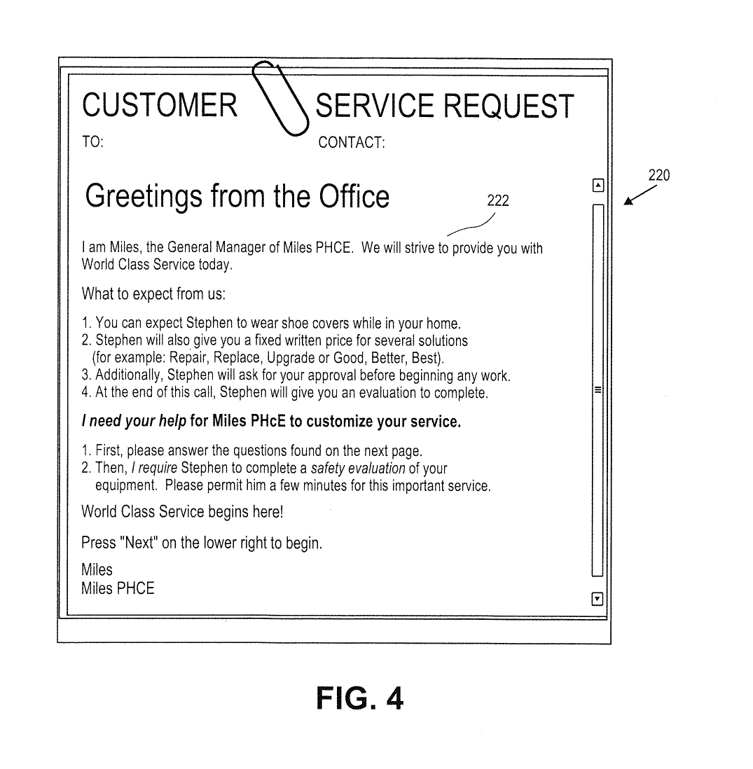

Once arriving at the in-house service visit location, the in-home service visit stage may begin, and the service technician may personally interact with the customer. In certain embodiments of the present invention, the customer may be given access to the service technician's computing device 204, such that the customer may interact with the computing device via the GUI. In additional embodiments, the customer may use the customer's own computing device 204, such that the customer may access the electronic resource of embodiments of the present invention from the customer's own computing device. As illustrated in FIG. 4, the customer may initially be presented with a customizable welcome screen 220 that includes a welcome message 222 that describes the purpose and goals of the visit and notifies the customer that the service technician is required to inspect the item that is the original subject of the primary service of the in-home service visit.

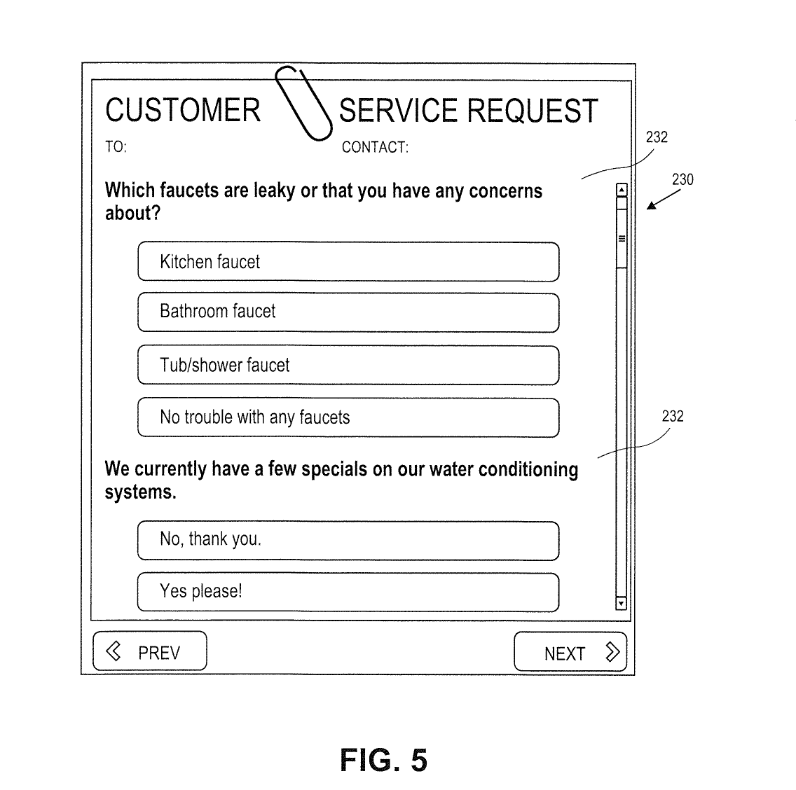

While the service technician is performing the inspection, the customer may be presented, as illustrated by FIG. 5, with a consumer question screen 230 that includes a series of customizable consumer questions 232 that can be used to determine if the customer may require any secondary services to be performed by the service technician. Thus, it is understood that secondary services are services that may be performed by the service technician that are beyond those services included as part of the primary service that were the original subject of the in-home service visit. The consumer questions 232 may include: questions directed to whether the customer has any other items in the user's home or property that may need to be inspected, maintained, repaired, or the like; questions as to whether the customer is interested in any specials or discounts currently being offered by the service company; questions as to whether specified items in the customer's home are in compliance with codes, regulations, or requirements, or the like. However, it is understood that consumer questions 232 are fully customizable and may include any questions that the service company considers pertinent to determine whether the customer requires the service technician to perform any secondary services. The customer may select answers, via the GUI, as may be appropriate by highlighting, selecting, or checking such appropriate answers. The answers selected by the customer may be analyzed to build a list of secondary package proposals directed to secondary services that may be performed by the service technician during the in-home service visit. As will be discussed in more detail below, package proposals are directed to primary and secondary services and may include information such as general descriptions of the services, listing of supplies included in the services, costs of the services, and labor time, Therefore, as a customer provides answers to the consumer questions, embodiments of the present invention dynamically filter through package proposals stored in the server 202 (or the associated database) to identify those package proposals that correspond to the customer's answers, and thus to services that the customer may need to have performed. In even further embodiments, the answers to the consumer questions 232 may be used and documented for subsequent reference and/or marketing purposes. For instance, if after numerous in-home service visits, the answers to the consumer questions indicate that a particular special offer provided by the service company is especially of interest to customers, then the service company may choose to expend more advertising and/or marketing efforts on promoting the particular special offer. In certain embodiments, the consumer questions may be bypassed if the customer is not interested in providing such information to the service technician or the service company.

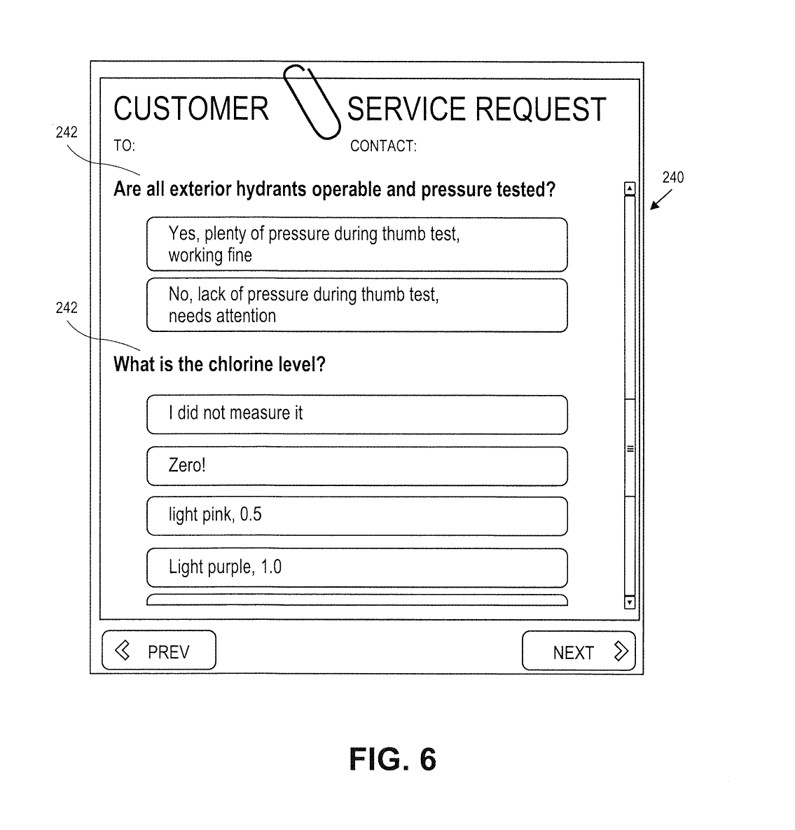

After performing the inspection of the item that is the original subject of the primary service of the in-home service visit, the service technician may be required, through interaction with a technician question screen 240, as illustrated in FIG. 6, to answer a series of customizable technician questions 242. The technician questions 242 may be directed to the inspection that was performed. The technician questions 242 may include questions directed to the item that was the original subject of the primary service of the in-home service visit. Alternatively, or in addition, the technician questions 242 may include questions directed at other items that the service technician observed during the inspection and that may correspond to one or more secondary services. The answers selected by the service technician may be analyzed to build a list of both primary package proposals directed to the primary service and secondary package proposals directed to secondary services that may be performed by the service technician during the in-home service visit. As was previously discussed above and as will be discussed in more detail below, package proposals are directed to primary and secondary services and may include information such as general descriptions of the services, listing of supplies included in the services, costs of the services, and labor time, Therefore, as a service technician provides answers to the technician questions, embodiments of the present invention dynamically filter through package proposals stored in the server 202 (or the associated database) to identify those package proposals that correspond to the service technician's answers, and thus to services that the customer may need to have performed. Further embodiments of the present invention may provide that the consumer questions 232 and the technician questions 242 may be simultaneously analyzed to determine potential primary and secondary package proposals directed to the primary service and the secondary services, respectively. For clarity, it is understood that primary package proposals include package proposals that correspond to a primary service, which is a service directed to the original subject of the in-home service visit. Contrastingly, secondary package proposals are directed to package proposals that correspond to a secondary service, which are additional services that may be performed in addition to the primary service during the in-home service visit.

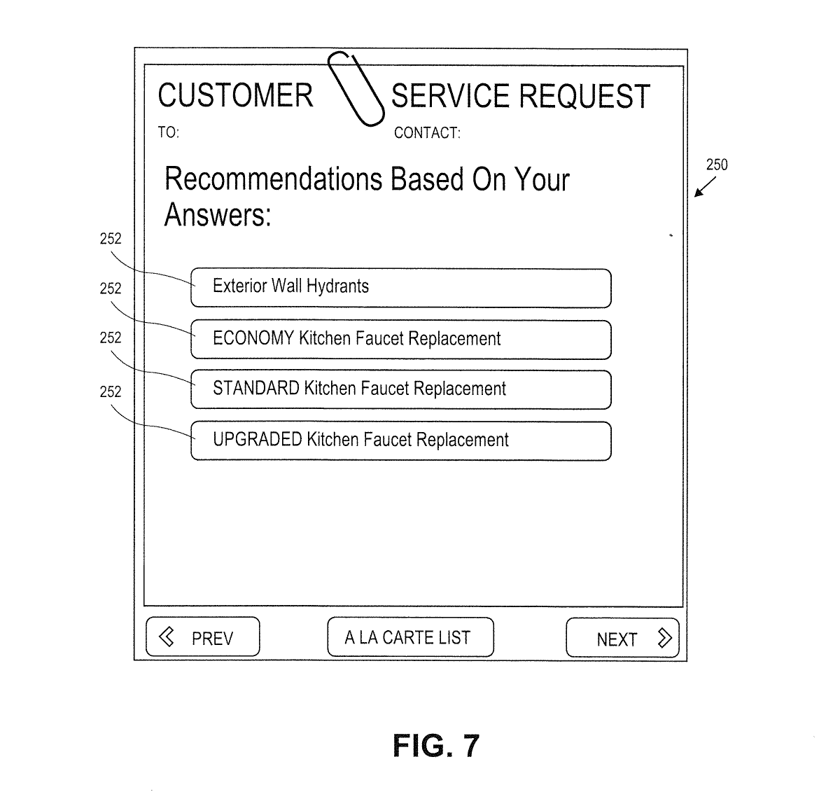

In further embodiments, the customer may be presented with a repair topics screen 250, such as illustrated by FIG. 7, which displays a list of recommended repair topics 252. Each of the displayed repair topics 252 corresponds to each of the primary and secondary services that were previously determined. The customer can select from the repair topics 252 those primary and secondary services that the customer would like to discuss in more detail with the service technician. The customer can select any number of the repair topics 252 to be discussed in more detail with the service technician. In further embodiments, the service technician, via embodiments of the present invention, can select and display additional hand-picked repair topics that are not originally listed in the repair topics 252, which may correspond to supplemental package proposals. Such supplemental package proposals may be selected similar to how specialty package proposals are selected, as discussed in detail below.

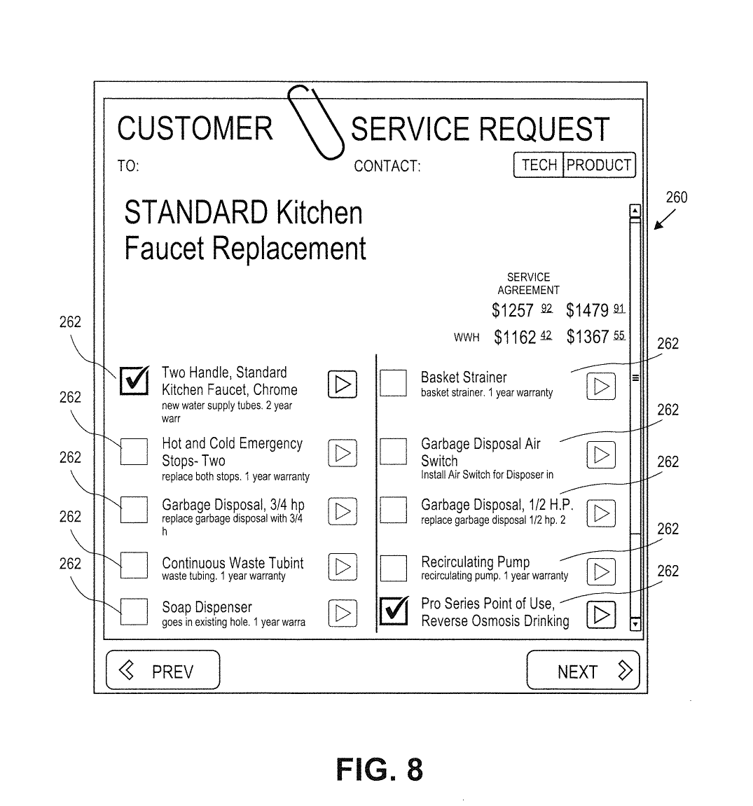

Once the repair topics have been selected, embodiments of the present invention provide for a package proposal screen 260, such as illustrated in FIG. 8, to be displayed with a list of package proposals 262. In certain embodiments, there may be multiple package proposal screens 260 displayed, with each package proposal screen directed to a primary and/or secondary services that were determined to correspond to requirements of the customer. The displayed package proposals 262 include each of the primary and secondary package proposals that were previously determined and that correspond to the repair topics selected by the customer. In certain embodiments, the previously discussed repair topics screen 250 may not be displayed, and the package proposal screen 260 may be displayed immediately after the primary and secondary services are determined. The presented package proposals 262 may include proposal information related to the package proposals, such as a general description of the service to be performed, a listing of supplies necessary to complete the service, the cost of the supplies, the labor time required to complete the service, and a total cost of the package proposal. In certain embodiments, the proposal information may additionally include clickable links that may be selected, via the GUI, to display audio and/or video messages directed to providing descriptions of the package proposals. Such descriptions may include a summary of the services, benefits of the services, the supplies used to complete the services, and any other information the service company considers pertinent to be provided to the customer. The proposal information directed to package proposals may be stored in the server device 202 or the associated database for access by the service technician's computing device 204, as displayed via the GUI. It is understood that the package proposals and corresponding proposal information is fully customizable, such that service companies may customize the package proposals, services, supplies, costs, and any other related information as may be necessary.

In some embodiments, certain specialty package proposals may not be immediately available for display because such specialty package proposals may not be commonly used. In such embodiments, the service technician may use the GUI to manually search for specialty package proposals that may not have been listed in the displayed package proposals 262. Because such specialty package proposals are not commonly used, the proposal information related to the specialty package proposals may only be accessed by manually searching the server device 202 or the associated database. Through the GUI, the service technician may manually search for the specialty package proposals by inputting certain types of search information regarding the specialty package proposals into search fields. Such search information may include names of the supplies associated with the specialty package proposals, a manufacturer of the supplies associated with the specialty package proposals, or a type of service of the specialty package proposal (i.e., whether the specialty package proposal is used for work related to electrical, plumbing, appliances, HVAC, or the like). After entering the search information, embodiments of the present invention may present a plurality of specialty package proposals that match or that are related to the search information. The presented specialty package proposals may be displayed in a list form, in an array form, or the like. Through the GUI, the service technician can navigate through the presented specialty package proposals until the appropriate specialty package proposal is found and can be presented to the customer. In even further embodiments, certain specialty products may be so unique that proposal information related to the specialty package proposals may not be stored in the server device 202 or the associated database. Thus, the service technician may be required to be manually write or type-in the proposal information into the GUI of the computing device 204, such that the proposal information can be presented to the customer. After the service technician manually writes the proposal information, the information may be transmitted and stored in the server device 202 for future use.

In certain embodiments of the present invention, after the package proposal screen 260 has been presented, the customer may be presented with an options screen that lists each of the primary and secondary services, along with selected package proposals that correspond to each of the primary and secondary services. The summary screen may allow the customer to view the different individual package proposals that are associated with each primary and/or secondary service. In addition, the customer may compare the package proposals and the prices for each of the presented primary and secondary services. For example, if the options screen lists a service for a “STANDARD” faucet replacement and also lists a service for an “UPGRADE” faucet replacement, the customer can compare the price differences between the services and the package proposal differences between the services on a single screen. Thus, the options screen may provide comparative pricing quotes for related services and may also provide pricing for services that contain the use of upgrades, such as upgraded supplies. In addition, the service technician may revise any of the presented primary and/or secondary services and associated package proposals, as may be required or requested by the customer. In certain other embodiments, the options screen may not be displayed, and a summary screen 270, as described below, may be displayed immediately after the package proposal screen 260.

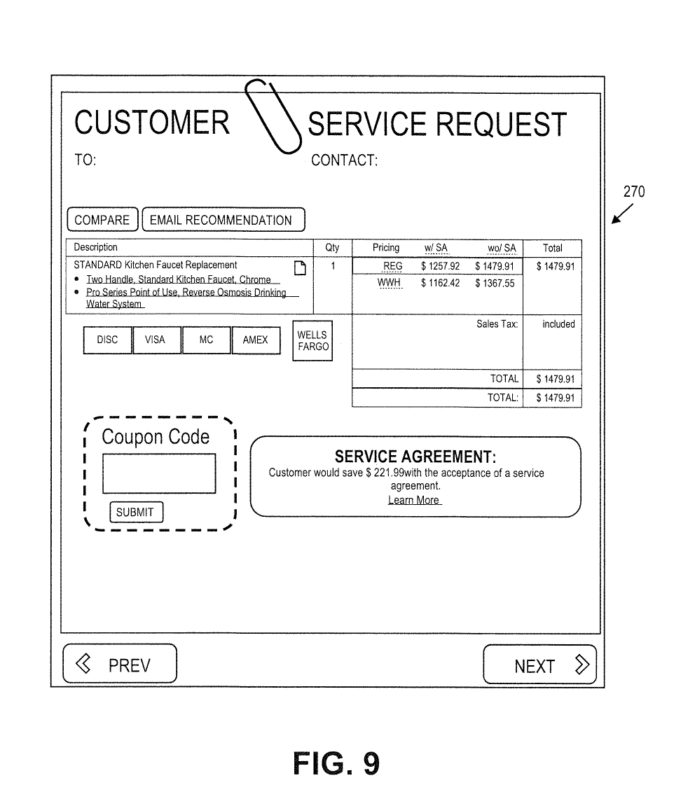

Once the package proposals 262 have been reviewed, the customer may select those package proposals that correspond to the primary and/or secondary services that the customer would like for the service technician to perform. Through the GUI, the service technician or the customer will select the appropriate package proposals 262 and the summary screen 270, such as illustrated in FIG. 9, will be displayed. The summary screen 270 may display each of the package proposals that were selected by the customer for purchase and that are to be performed by the service technician. The summary screen 270 may further list individual and total pricing packages for the selected package proposals. The summary screen 270 may include multiple pricing packages for each package proposal. For instance, each package proposal may include a regular (or “REG”) pricing and a while-we're-here (or “WWH”) pricing. The regular pricing is a normal price that is charged by the service company to perform a primary service. The while-we're-here pricing is a pricing that is charged for a secondary service that can be performed during the in-home visit, in addition to the primary service. The while-we're-here pricing may be lower than the regular pricing for the same service because the service technician is already at the customer's residence, and certain costs (e.g., fuel, travel time, etc.) may not be required to be included. An example of a regular pricing may include the following elements as part of the pricing calculation: labor time, material costs, travel costs, and an upcharge. However, while-we're-here pricing may only include labor time, material costs, and the upcharge, while not including the travel costs. Thus, if in addition to a package proposal directed to a primary service (i.e., a primary package proposal priced at the regular pricing), a customer selects one or more package proposals directed to secondary services (i.e., a secondary package proposal priced at the while-we're-here pricing), then a total price of a sum of each of package proposals is generally less than the sum of the individual package proposals for each of the individual package proposals priced according to their regular pricing.

In additional embodiments, some package proposals may be displayed at a reduced service agreement (or “SA”) pricing if the services to be performed are performed under a service agreement. A service agreement is a contractual arrangement between the customer and the service company, whereby the customer agrees to pay the service company a fee (e.g., a flat fee, a periodic fee, etc.) in exchange for a reduced service agreement pricing on any package proposals purchased during the duration of the contractual arrangement. An example of a reduced service agreement pricing may include the following elements as part of the pricing calculation: labor time, material costs, travel costs. Thus, in certain embodiments, the upcharge applicable to the regular pricing may be reduced or eliminated. The summary screen 270 may include a description and explanation of such a service agreement and the benefits of entering into the agreement. Such a description may be presented in a textual, graphic, and/or audio format. Further embodiments may provide for a fully customizable video to be displayed to the customer, which describes the service agreement in detail.

The summary screen 270 also includes various methods of providing discounts to the customer for the services to be performed. The summary screen 270 may provide for the customer to enter discount information (such as coupon numbers, discount codes, etc.), which permits the customer to receive a discount in return for using the discount information. The customer may also receive a discount for agreeing to perform certain advertising functions for the service company, such as promoting the service company through online social networks (e.g., providing links on the customer's Facebook™, Twitter™, Instagram™ accounts), placing advertising signs in their yard, placing stickers on their appliances, or the like. In addition to the discounts, the summary screen 270 may allow customers to choose to donate money to a charity or charitable organization. In certain embodiments the service company or another participating company may choose to match the donations made by the customer. From the summary screen 270, the service technician can perform any final edits of the selected package proposals to correct any mistakes or to support any last minute changes by the customer.

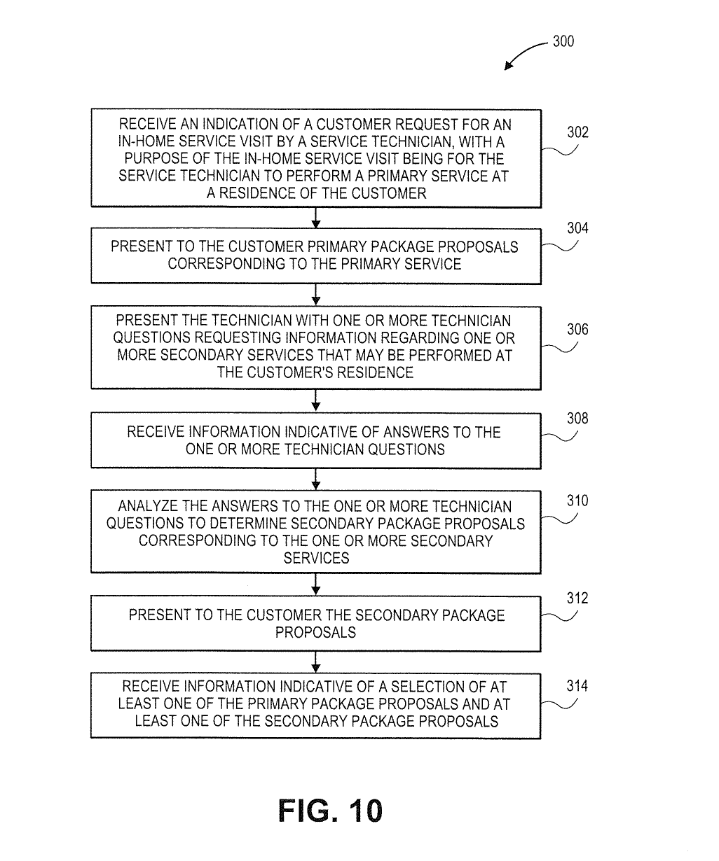

Thus, embodiments of the present invention include an additional method for facilitating in-home service visits. As illustrated in FIG. 10, embodiments of the present invention may include a method 300 with an initial Step 302 of receiving an indication of a customer request for the in-home service visit by a service technician, with a purpose of the in-home service visit being for the service technician to perform a primary service at a residence of the customer. For example, the primary service may be to perform maintenance on the customer's bathroom sink, which has a leaking faucet. In the next Step 304, the customer is presented with primary package proposals corresponding to the primary service. For instance, the primary package proposals may include various choices of tools, equipment, or supplies that can be used by the service technician to perform the primary service. In Step 306, the service technician is presented with one or more technician questions requesting information regarding one or more secondary services that may be performed at the customer's residence. For instance, the service technician may be asked whether he observed, during his initial inspection, whether the customer had any additional services that may need to be performed. As an example, the technician question may include whether if during his inspection of the bathroom sink, the service technician tested the customer's water “pH” level. In the next Step 308, information indicative of answers to the one or more technician questions is received. Thereafter, in Step 310, embodiments of the present invention analyze the answers to the one or more technician questions to determine secondary package proposals corresponding to the one or more secondary services. In the next Step 312, the customer is presented with the secondary package proposals. Remaining with the example above, if the technician indicates that the customer's water was highly acidic, then embodiments of the present invention may present a secondary package proposal directed to balancing the customer's “pH” level. Finally, in Step 314, information indicative of a selection of at least one of the primary package proposals and at least one of the secondary package proposals is received. Thus, embodiments of the present invention are directed to facilitating in-home service visits, and particularly to facilitating a service technician's interaction with a customer during performance of an in-home service visit.

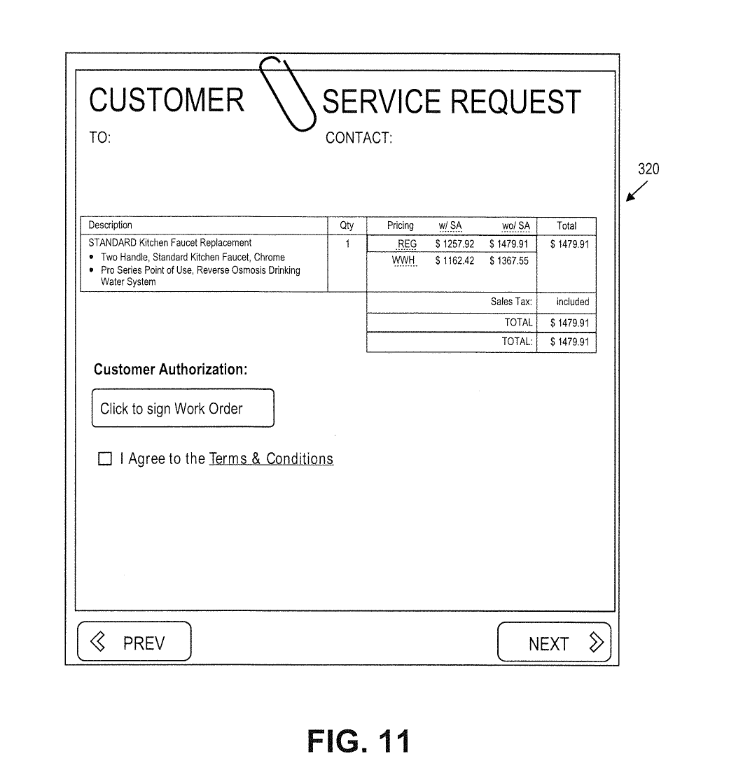

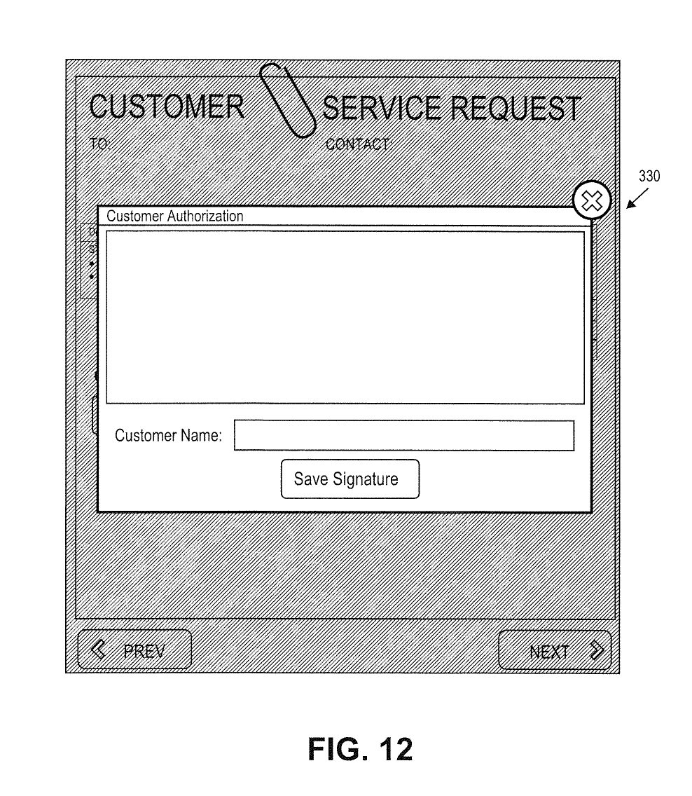

Once the customer is satisfied with the selected package proposals and pricing, embodiments of the present invention provide for a work order screen 320, such as illustrated in FIG. 11, to be displayed via the GUI. The work order screen 320 displays each of the package proposals corresponding to the primary and secondary services that will actually be performed by the service technician and the individual and total pricing, less any discounts. The work order screen 320 may also display a fully customizable set of terms and conditions, which the customer may be required to acknowledge having read. Thereafter, as illustrated by FIG. 12, the customer can electronically sign, via the GUI, the work order by way of signature screen 33. The signature may be used to verify that the customer accepts the offer and permits the service technician to begin the services. The work order may be physically signed by interacting with a touchscreen of the GUI to add the customer's signature to the signature screen 330.

The service technician may then enter, via the GUI, an estimated time that it will take to complete each of the primary and secondary services corresponding to the package proposals selected by the customer. The estimated time may be sent to the administrative user as an alert or notification. In even further embodiments, the service technician does not completely understand how to perform a service, embodiments of the present invention may provide for instructional videos to be displayed to the service technician. The instructional videos are fully customizable and may be related to technical areas for which the technician is unfamiliar or has not been fully trained. For example, if the customer selected a package proposal that required the service technician to replace a toilet seat, the service technician may be presented with an instructional video that provides step-by-step instructions as to how a toilet seat is replaced. In further embodiments, the service technician may communicate, via the computing device 204, in real-time with the administrative user, such that the service technician can request specific instructions or other assistance. In even further embodiments, the present invention may be functional to send an emergency alert signal to the administrative user. Such emergency alert signal may be used for instance if the service technician is involved in an accident, is under duress, or is otherwise in need of emergency assistance.

Thereafter, the service technician may begin performing each of the primary and secondary services corresponding to the selected package proposals. In certain embodiments, the service technician may take images and/or videos of the items or areas that are the subject of the primary and/or secondary services. Such images may be used for recordkeeping, advertising, insurance, fraud-prevention, or the like. As with all information and data collected via embodiments of the present invention, the images and/or videos may be uploaded to the server devices 202 and or associated databases. In further embodiments, the images and/or videos may associated with the customer or the customer account (if applicable) in the database.

Once the technician has finished each of the primary and secondary services corresponding to the selected package proposals, the service technician may input, via the GUI, that the work has been finished. Thereafter, an alert or notification may be sent to the administrative user notifying the administrative user that the services have been completed. Upon receiving the notification, the administrative user may begin locating and preparing a future in-home service visit for the service technician to perform. While the administrative user is preparing the next in-home service visit, the technician may be instructed, through the GUI, to perform a walk-through of the work site to inspect the performed services and surrounding areas. In certain embodiments, the service technician may take images or videos of the items or areas that were the subject to the primary and/or secondary services. Such images may be used for recordkeeping, advertising, insurance, fraud-prevention, or the like. For instance, images obtained after the service technician has performed the in-home service visit may be compared with the images obtained before the in-home service visit was performed, such that the customer and/or service company can evaluate the service technician's work.

Once the walk-through is complete, embodiments of the present invention provide for the customer to select whether to have an invoice and/or receipt electronically or physically delivered. If the customer prefers to receive the invoice and/or receipt electronically, the customer may be required to enter an email address into the GUI. Thereafter, an invoice may be sent to the customer's email address. If the customer is a repeat customer, certain embodiments may provide for certain customer information, such as physical addresses and email addresses to be stored in the server device 202. Thus, the customer may not be required to re-enter an email address each time a service is performed. If the customer does not have access to email, a physical copy of the invoice may be printed or mailed to the customer.

Embodiments of the present invention may provide at least three options by which the customer may make a payment for the performed services. Such options may include check, cash, or credit card. The service technician may physically accept check and cash payments. If the customer is paying with cash, the technician may be required to verify and digitally sign for the amount of cash received via the GUI. If the customer is paying with check, the technician may be required to enter certain information into the GUI, including check number, driver's license number, date of birth, etc. If the customer is paying with a credit card, the technician may be required to enter the credit card information into the GUI (e.g., primary account number, expiration date, security code, etc.). In further embodiments, the service technician's computing device 204 may include a magnetic strip reader, such that the customer's credit card information may be obtained by swiping a credit card's magnetic stripe. Once the credit card information has been entered, embodiments of the present invention provide for the credit card payment to be immediately processed electronically.

After the customer has paid for the services performed by the service technician, embodiments of the present invention provide for completion of the post-service visit stage. To begin, a survey screen may be displayed via the GUI, wherein the customer may be requested to perform a short satisfaction survey, such that embodiments of the present invention may obtain service satisfaction information. The service satisfaction information may include information related to the customer's level of satisfaction of the services performed by the service technician. If the customer is completely satisfied, the customer is not required to input any further information. If the customer is not completely satisfied, a short list of complaints may be displayed and presented to the customer, so as to obtain further information as to why the customer is not completely satisfied. Such reasons may include, price, quality, service, or the like. Once the further information is obtained, the customer is not required to input any further information.

Thereafter, the service technician leaves the customer's residence and re-enters the service technician's service vehicle. While in the service vehicle, the service technician may be presented with a re-order screen, which is displayed via the GUI, whereby the technician can re-order the supplies that were used during the performance of the services during the in-home service visit. Certain embodiments of the present invention provide for the supplies to be automatically re-ordered. In such embodiments, the supplies that were required to have been used during completion of the selected package proposals may be automatically queued for re-order. Embodiments of the present invention are functional to search through available equipment provider and/or distributor databases and automatically re-order the required supplies based on customizable parameters, such as timing, supply, and pricing. For instance if a specific item is available for re-order from multiple distributors, embodiments may automatically re-order the item from distributor that has the lowest price, the quickest shipment, or the other beneficial criteria. In addition to the automated re-order, certain supplies may be specialty supplies and are considered part of a control inventory. Such specialty supplies may be included in control inventory because they are expensive, hazardous, or otherwise required to be under positive control. For instance, if the service technician was required to install an expensive light fixture during the previous in-home visit, such a light fixture may be part of a control inventory because the light fixture is a high-priced specialty supply. For control inventory supplies, the reorder screen may require the service technician to associate the specialty supplies with a particular component of the service that was the subject of the completed in-home service visit.

Once the service technician has completed the re-order process, an upload screen is displayed, via the GUI, which allows the technician to upload and send to the administrative user or the service company any notes, comments, photos, or other information that was collected during or is related to the completed in-home service visit. Such information may be stored in the server device 202 or the associated database for recordkeeping or future use. Embodiments of the present invention then provide for a series of post-op questions to be displayed to the service technician. The post-op questions are fully customizable and may relate to the work performed or may be motivational in nature. The technician must correctly answer the post-op questions through the GUI before finishing with the in-home service visit.

If the administrative user has found an additional in-home service visit for the service technician to perform, embodiment of the present invention provide for the service call screen to be re-displayed and the above described process may begin again.

Embodiment of the present invention provide for all of the information that is displayed and entered by technicians, customers, admin users, etc. to be collected and stored in the computing device 204, the server device 202, or the associated databases for future review, documentation, and/or analysis. Such information may be collected for business requirements such as documentation, payroll, and inventory analysis, or the information may be analyzed and used for marketing, research, and reporting purposes. The collected information may include invoices, sales figures, signatures, GPS locations, or any other data and/or information collected, input, or otherwise available through embodiments of the present invention.

In addition, service technician statistics may be obtained, analyzed, and displayed to the service technician or the service company. The service technician statistics may include information related to the number and timing of the service technician's in-home service visits, the number of satisfied/dissatisfied customers, the number of sales made by the service technician, or other similar information. In such embodiments, the technician can review daily, weekly, monthly, and yearly service technician statistics. In particular, embodiments of the present invention provide for the financial information of the previous five quarters to be displayed to the service technician, such that the service technician can review and compare year to year sales figures, taking into consideration seasonal variations. Additional performance indicators and sales opportunity ratios may also be displayed. Such indicators may include profits, margins, or cost breakdowns, whereby the technician can monitor, review and improve performance.

In even further embodiments, all information collected via embodiments of the present invention during an in-home service visit may be saved in the server device 202 and reviewed and/or replayed for further analysis. Thus, all information that was entered by the service technician and the customer, along with all information that was presented to the service technician and customer can be saved for review. Even further, embodiments of the present invention can determine and store the sequences that information was presented to the customer and the amount of time the service technician spent on any one portion of the in-home service visit. Thus, for instance, the service company and/or the administrative user can review which package proposals the service technician presented and discussed with the customer, and further, the amount of time the service technician spent discussing the package proposals with the customer. Such a review may be used by service companies for training and/or coaching sessions for their service technicians. For example, the service company and/or administrative user may review the package proposals that were offered to the customer by the service technician and determine that the service technician failed to offer or discuss a particular package proposal that the service company was offering at a reduced price. Thus, the administrative user may coach the service technician to insure that the service technician always offers and discusses with customers those package proposals that are offered at reduced prices. As an additional example, the service company and/or the administrative user may review the amount of time that the service technician spent discussing a particular package proposal with the customer. If the administrative user feels that not enough time was spent discussing the particular package proposal with the customer, the administrative user may coach the service technician to spend additional time and/or to perform more in-depth discussions with customers with respect to promoting the particular package proposal. Thus, embodiments of the present invention provide for service companies and/or administrative users to train and/or coach their service technicians to improve on technical and behavioral aspects of conducting the in-home service visits.

In still further embodiments, service companies, such as through administrative users, may monitor the actions of the service technicians and/or the customers in real-time. Thus, the administrative user may perform a “virtual ride-along” with the service technician as the service technician performs the in-home service visit. For example, the administrative user may review the actions of the service technician while the service technician is performing an in-home service visit. The administrative user may make notes about the in-home service visit and upload the notes to the server device 202, such that the notes are later available to the administrative user and/or the service technician for coaching, training, and/or review purposes. In even further embodiments, the administrative user may send messages to the service technician's computing device 204 in real-time. Thus, if while performing a virtual ride-along, the administrative user notices that the service technician failed to discuss a specially priced package proposal with the customer, the administrative user may send the service technician an alert, such as via a text message, reminding the service technician to discuss the specially priced package proposal with the customer. By viewing and/or reviewing the actions, functions, and features of the service technician and/or customer in real-time, embodiments of the present invention provide for complete and continuous oversight and monitoring of in-home service visits.

Although this invention has been described with its preferred embodiment(s), it is noted that equivalents may be employed and substitutions made herein without departing from the scope of the invention.

Having thus described various embodiments of the invention, what is claimed as new and desired to be protected by Letters Patent includes the following:

1. A non-transitory computer readable storage medium with an executable program stored thereon for facilitating an in-home service visit, wherein the program instructs a processor to perform the following steps:
receive an indication of a customer request for the in-home service visit to be performed by a service technician,
wherein a purpose of the in-home service visit is for the service technician to perform a primary service at a residence of the customer;
present to the customer primary package proposals corresponding to the primary service;
present the customer with one or more consumer questions requesting information regarding one or more secondary services that may be performed at the customer's residence;
receive information indicative of answers to the one or more consumer questions;
analyze the answers to the one or more consumer questions to determine secondary package proposals corresponding to the one or more secondary services; and
present to the customer the secondary package proposals.

2. The computer readable storage medium of claim 1, wherein the computer program further instructs the processor to perform the following steps:
present the service technician with one or more technician questions requesting information regarding one or more secondary services that may be performed at the customer's residence;
receive information indicative of answers to the one or more technician questions; and
analyze the answers to the one or more technician questions to determine the secondary package proposals corresponding to the one or more secondary services.

3. The computer readable storage medium of claim 1, wherein the presented primary and secondary package proposals include one or more of the following: a description of the primary and secondary services, an amount of time required to perform the primary and secondary services, and a description of the material necessary to complete the primary and secondary services.

4. The computer readable storage medium of claim 1, wherein the computer program further instructs the processor to perform the following steps:
present the customer with a video or an image describing the presented primary and secondary package proposals.

5. The computer readable storage medium of claim 1, wherein the presented primary and secondary package proposals include individual prices for each of the presented package proposals.

6. The computer readable storage medium of claim 5, wherein the computer program further instructs the processor to perform the following steps:
receive information indicative of a selection of at least one of the primary package proposals and at least one of the secondary package proposals; and
present to the customer a summary of all of the primary and secondary package proposals selected by the customer.

7. The computer readable storage medium of claim 6, wherein the presented summary includes a total price of all of the selected primary and secondary package proposals.

8. The computer readable storage medium of claim 7, wherein the total price of each of the selected primary and secondary package proposals is less than a sum of the individual prices of the selected package proposals.

9. The computer readable storage medium of claim 1, wherein the primary and secondary services are directed to services corresponding to: heating ventilation and air conditioning, plumbing, appliances, or electrical.

10. A method for facilitating an in-home service visit, comprising the following steps:
receiving an indication of a customer request for the in-home service visit to be performed by a service technician,
wherein a purpose of the in-home service visit is for the service technician to perform a primary service at a residence of the customer;
presenting the customer with primary package proposals corresponding to the primary service;
presenting the customer with one or more consumer questions requesting information regarding one or more secondary services that may be performed at the customer's residence;
receiving information indicative of answers to the one or more consumer questions;
analyzing the answers to the one or more consumer questions to determine secondary package proposals corresponding to the one or more secondary services; and
presenting to the customer the secondary package proposals.

11. The method of claim 10, wherein the computer program further instructs the processor to perform the following steps:
presenting the service technician with one or more technician questions requesting information regarding one or more secondary services that may be performed at the customer's residence;
receiving information indicative of answers to the one or more technician questions; and
analyzing the answers to the one or more technician questions to determine the secondary package proposals corresponding to the one or more secondary services.

12. The method of claim 10, wherein the presented primary and secondary package proposals include one or more of the following: a description of the primary and secondary services, an amount of time required to perform the primary and secondary services, and a description of the material necessary to complete the primary and secondary services.

13. The method of claim 10, wherein the computer program further instructs the processor to perform the following steps:
presenting the customer with a video or an image describing the presented primary and secondary package proposals.

14. The method of claim 10, wherein the primary and secondary service are directed to services corresponding to: heating and air conditioning, plumbing, appliances, or electrical.

15. A non-transitory computer readable storage medium with an executable program stored thereon for facilitating an in-home service visit, wherein the program instructs a processor to perform the following steps:
receive an indication of a customer request for the in-home service visit to be performed by a service technician,
wherein a purpose of the in-home service visit is for the service technician to perform a primary service at a residence of the customer;
present the service technician with one or more technician questions requesting information regarding one or more secondary services that may be performed at the customer's residence;
receive information indicative of answers to the one or more technician questions;
analyze the answers to the one or more technician questions to determine primary package proposals corresponding to the primary service and secondary package proposals corresponding to the one or more secondary services; and
present to the customer the primary package and the secondary package proposals.

16. The computer readable storage medium of claim 15, wherein the computer program further instructs the processor to perform the following steps:
present the customer with one or more consumer questions requesting information regarding one or more secondary services that may be performed at the customer's residence;
receive information indicative of answers to the one or more consumer questions; and
analyze the answers to the one or more consumer questions to determine secondary package proposals corresponding to the one or more secondary services.

17. The computer readable storage medium of claim 15, wherein the presented primary and secondary package proposals include one or more of the following: a description of the primary and secondary services, an amount of time required to perform the primary and secondary services, and a description of the material necessary to complete the primary and secondary services.

18. The computer readable storage medium of claim 15, wherein the computer program further instructs the processor to perform the following steps:
present the customer with a video or an image describing the presented primary and secondary package proposals.

19. The computer readable storage medium of claim 15, wherein the primary and secondary services are directed to services corresponding to: heating and air conditioning, plumbing, appliances, or electrical.
